(19) United States
(12) Patent Application Publication
(10) Pub. No.: US 2023/0408263 A1
(43) Pub. Date: Dec. 21, 2023

(54) ELECTRIC POWER INSPECTION METHOD, UNMANNED AERIAL VEHICLE AND STORAGE MEDIA

(71) Applicant: SZ DJI TECHNOLOGY CO., LTD., Shenzhen (CN)

(72) Inventors: Di GAO, Shenzhen (CN); Huangjian ZHU, Shenzhen (CN); Shirong WANG, Shenzhen (CN)

(73) Assignee: SZ DJI TECHNOLOGY CO., LTD., Shenzhen (CN)

(21) Appl. No.: 18/241,245

(22) Filed: Sep. 1, 2023

Related U.S. Application Data
(63) Continuation of application No. PCT/CN2021/079151, filed on Mar. 4, 2021.

(51) Int. Cl. G01C 21/20; G05D 1/10

(52) U.S. Cl. CPC G01C 21/20; G05D 1/106

(57) ABSTRACT

An operating method of an aerial vehicle may comprise obtaining target parameters, the target parameters being acquired by an on-board sensor of the aerial vehicle during movement of the aerial vehicle, the target parameters comprising a distance between the aerial vehicle and a target object and an extension direction of the target object; determining a flight path of the aerial vehicle based on the target parameters; and controlling the aerial vehicle to perform an operation based on the flight path of the aerial vehicle.

### CROSS-REFERENCE TO RELATED APPLICATION

The present application is a continuation of International Application No. PCT/CN20211079151, filed Mar. 4, 2021, the entire contents of which being incorporated herein by reference in its entirety.

### TECHNICAL FIELD

The present application relates to the field of inspection technology, and in particular to an electric power inspection method, an unmanned aerial vehicle and a storage medium.

### BACKGROUND

In the electric power inspection industry, it is often necessary to inspect high voltage towers and electric wires to anticipate faults in advance. Currently, the operation mode of electric power inspection has an operation mode of unmanned aerial vehicle (UAV) inspection. The operation mode of UAV inspection can be divided into manual flight operation mode and automatic flight operation mode. The manual flight operation mode has higher requirements for the flyer, and efficiency of the inspection line is relatively low; the automatic flight operation mode requires real-time kinematic (RTK) data acquisition of the flight track in advance.

However, new obstacles are likely to appear on the flight trajectory obtained from RTK acquisition as time changes, posing a threat to the UAV.

### SUMMARY

According to a first aspect of the present disclosure, an operating method of an aerial vehicle may comprise obtaining target parameters, the target parameters being acquired by an on-board sensor of the aerial vehicle during movement of the aerial vehicle, the target parameters comprising a distance between the aerial vehicle and a target object and an extension direction of the target object; determining a flight path of the aerial vehicle based on the target parameters; and controlling the aerial vehicle to perform an operation based on the flight path of the aerial vehicle.

In one embodiment, the target object comprises an electric wire.

In one embodiment, the on-board sensor comprises a point cloud sensor.

In one embodiment, the point cloud sensor comprises at least one of the following: a lidar, a visible camera, a multispectral camera, a millimeter wave radar, a rotating millimeter wave radar, or an ultrasonic radar.

In one embodiment, a heading direction of the aerial vehicle is substantially aligned with the extension direction of the target object.

In one embodiment, the distance between the aerial vehicle and the electric wire includes a horizontal distance between the aerial vehicle and the electric wire and a vertical height between the aerial vehicle and the electric wire.

In one embodiment, the obtaining target parameters comprises:

obtaining target measurement data collected by the on-board sensor; and

determining the target parameters based on the collected target measurement data.

In one embodiment, prior to the obtaining target measurement data collected by the on-board sensor, further comprising:

determining whether measurement data collected by the on-board sensor is the target measurement data;

the obtaining target measurement data collected by the on-board sensor comprises:

obtaining the target measurement data collected by the on-board sensor when the measurement data is determined to be the target measurement data.

In one embodiment, the determining whether the measurement data collected by the on-board sensor is the target measurement data comprises:

determining whether the measurement data is the target measurement data based on a dispersion of the measurement data.

In one embodiment, the determining whether the measurement data is the target measurement data based on a dispersion of the measurement data comprises:

under a condition that the dispersion is less than or equal to a predetermined threshold, the measurement data is determined to be the target measurement data; and

under a condition that the dispersion is greater than the predetermined threshold, the measurement data is determined to be obstacle measurement data, which is measurement data of an obstacle other than the target object.

In one embodiment, the determining the flight path of the aerial vehicle based on the target parameters comprises:

determining the flight path of the aerial vehicle based on the target parameters and a predetermined requirement for the aerial vehicle to follow the target object.

In one embodiment, the determining the flight path of the aerial vehicle based on the target parameters and the predetermined requirement for the aerial vehicle to follow the target object comprises:

determining a heading direction of the aerial vehicle based on the extension direction of the target object;

determining the flight path of the aerial vehicle in the heading direction based on the target parameters, a position of the aerial vehicle, and a predetermined distance between the aerial vehicle and the target object.

In one embodiment, the operating method further comprises:

determining presence of an obstacle other than the target object, the obstacle being determined by measurement data collected by the on-board sensor during the movement of the aerial vehicle; and

determining that the obstacle is within the flight path of the aerial vehicle and controlling the aerial vehicle to enter an obstacle avoidance mode to avoid the obstacle, or

determining that the obstacle is outside the flight path of the aerial vehicle and controlling the aerial vehicle to ignore the obstacle.

According to a second aspect of the present disclosure, an aerial vehicle having an on-board sensor may comprise: a memory and a processor; the memory is used to store instructions; the processor calls the instructions stored in the memory for realizing following operations:

obtaining target parameters, the target parameters being acquired by an on-board sensor of the aerial vehicle during movement of the aerial vehicle, the target parameters comprising a distance between the aerial vehicle and a target object and an extension direction of the target object;

determining a flight path of the aerial vehicle based on the target parameters; and

controlling the aerial vehicle to perform an operation based on the flight path of the aerial vehicle.

According to a third aspect of the present disclosure, a non-transitory computer-readable storage medium is provided, and the computer-readable storage medium storing a computer program, the computer program when executed by a processor causing said processor to implement an operating method of an aerial vehicle as described in any of embodiments of the present application.

It should be understood that the above general description and the following detailed description are only exemplary and explanatory and are not restrictive of the present disclosure.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art may obtain other drawings and features based on these disclosed drawings without inventive efforts.

FIG. 1 is a flowchart of an electric power inspection method according to one embodiment of the present application;

FIG. 2 is a flow diagram of an electric power inspection method according to one embodiment of the present application;

FIG. 3 is a flow diagram of an electric power inspection method according to one embodiment of the present application;

FIG. 4 is a flow diagram of an electric power inspection method according to one embodiment of the present application;

FIG. 5 is a schematic diagram of electric wire parameters in a power inspection method according to one embodiment of the present application;

FIG. 6 is a schematic diagram of a way to handle an obstacle other than an electric wire in the power inspection method according to one embodiment of the present application;

FIG. 7 is a schematic diagram of a structure of an unmanned aerial vehicle according to one embodiment of the present application.

### DETAILED DESCRIPTION

The technical solutions in some embodiments of the present application will be clearly and completely described below in conjunction with the drawings in the embodiments of the present application. Obviously, the described embodiments are part of the embodiments of the present application, not all of them. Based on the embodiments in the present application, all other embodiments obtained by a person of ordinary skill in the art without making creative labor fall within the scope of protection of the present application.

The technical solutions in the embodiments of the present application will be clearly and completely described below in conjunction with the accompanying drawings in the embodiments of the present application.

The flow chart shown in the accompanying drawings is only an example illustration and is not necessary to include all contents and operations/steps, nor is it necessary to perform them in the order depicted. For example, some of the operations/steps may also be decomposed, combined or partially merged, and thus the actual order of execution may change depending on the actual situation.

At present, the operation mode of electric power inspection has the automatic flight operation mode of UAV inspection, which needs to collect RTK data on a flight trajectory in advance or through a visual detection program to guarantee a safe flight distance. However, new obstacles are likely to appear on the flight trajectory collected in advance, thereby posing a threat to the UAV. It is often difficult to detect thin wires in the visual inspection program. In the present application, electric wire and wire are interchangeably used.

Some embodiments of the present application provide an operating method of an aerial vehicle, an aerial vehicle, and a storage medium. The operating method of the aerial vehicle may include obtaining target parameters, the target parameters being acquired by an on-board sensor of the aerial vehicle during movement of the aerial vehicle, the target parameters comprising a distance between the aerial vehicle and a target object and an extension direction of the target object; determining a flight path of the aerial vehicle based on the target parameters; and controlling the aerial vehicle to perform an operation based on the flight path of the aerial vehicle. In one embodiment, the target object comprises an electric wire. In one embodiment, the on-board sensor comprises a point cloud sensor.

In some embodiments, the operating method may include obtaining electric wire parameters, the electric wire parameters being acquired by a point cloud sensor during movement of an unmanned aerial vehicle, the electric wire parameters comprising a distance between the unmanned aerial vehicle and an electric wire, and an extension direction of the electric wire; determining a flight path of the unmanned aerial vehicle based on the electric wire parameters; and controlling the unmanned aerial vehicle to carry out an electric power inspection operation based on the flight path of the UAV. Compared to the existing technology in which RTK data acquisition of the flight path is required for the automatic flight of the electric power inspection operation, the embodiment of the present application determines the flight path of the UAV based on the electric wire parameters including the distance between the UAV and the electric wire and the extension direction of the electric wire, according to which the UAV is controlled to carry out the electric power inspection operation as the electric wire parameters are acquired by the point cloud sensor of the UAV during the course of movement. In this way, the unmanned aerial vehicle can avoid various obstacles in a timely manner according to the flight path to avoid the various obstacles that otherwise poses a threat to the unmanned aerial vehicle; compared to the existing technology in which it is often difficult to detect thin wires in the visual detection program, the unmanned aerial vehicle of one embodiment of the present application is capable of detecting thin wires through the acquisition of the wire parameters including the distance between the unmanned aerial vehicle and the wires and the extension direction of the wires by the point-cloud sensor of the UAV in the course of movement. The embodiments of the present application can be used to assist in realizing the automated operation of electric power inspection, and can ensure the safety of the unmanned aerial vehicle while enhancing the efficiency of the electric power inspection operation; and if the point cloud sensor adopts millimeter-wave radar, LiDAR, or other sensors that are not affected by the ambient light, the point cloud sensor has a high anti-jamming ability.

Some embodiments of the present application are described in detail below in conjunction with the accompanying drawings. The following embodiments and features in the embodiments may be combined with each other without conflict.

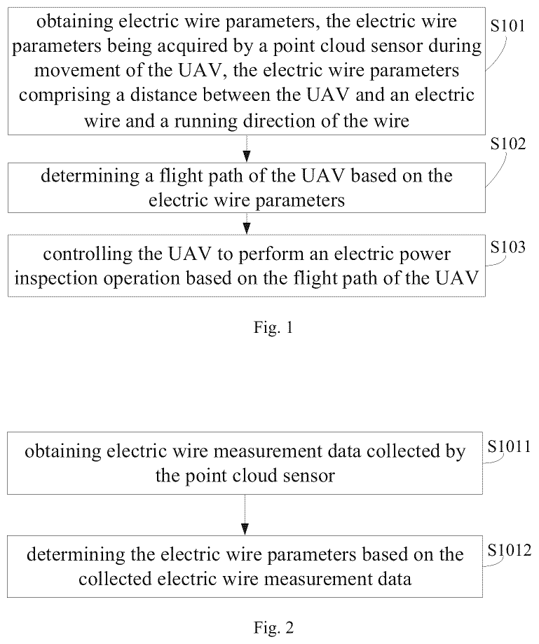

Referring to FIG. 1, FIG. 1 is a flowchart of a method for electric power inspection according to an embodiment of the present application, wherein the method of the embodiment of the present application is applied to an unmanned aerial vehicle, the unmanned aerial vehicle being provided with a point cloud sensor.

A point cloud can be a dataset of sampled points on a target surface obtained by a measuring instrument. A sampled point may contain a wealth of information, including 3D coordinates (XYZ), color, classification value, intensity value, time, and so on. For example, the point cloud obtained according to a principle of laser measurement includes three-dimensional coordinates (XYZ) and laser reflection intensity (Intensity), the point cloud obtained according to a principle of photogrammetry includes three-dimensional coordinates (XYZ) and color information (RGB), and the point cloud obtained by combining the principles of laser measurement and photogrammetry includes three-dimensional coordinates (XYZ), laser reflection intensity and color information. After obtaining the spatial coordinates of the sampled points on the target surface, a collection of points is obtained, which is called a “Point Cloud.” A point cloud sensor (i.e., a measurement instrument) may be a sensor that can be used to acquire at least three-dimensional data from the sampled points on the target surface, and may include, but is not limited to, LIDAR, a visible camera, a multispectral camera, a millimeter-wave radar, a rotating millimeter-wave radar, an ultrasonic radar, and the like, or a combination of these sensors.

In an embodiment, the point cloud sensor comprises a rotating millimeter wave radar. The rotating millimeter wave radar has both an advantage of rotating measurement and an advantage of millimeter wave radar. The rotating millimeter wave radar can perform rotating measurement, and thus can provide all-around measurement without dead angle, and provide technical support to ensure all-around safety of the UAV. Millimeter wave radar can be a radar working in the millimeter wave band (millimeter wave) detection, usually millimeter wave refers to the 30-300 GHz frequency domain (wavelength of 1-10 mm). A wavelength of a millimeter wave is between a wavelength of a micrometer wave and a wavelength of a centimeter wave, so a millimeter wave radar has some advantages of both the microwave radar and the photoelectric radar. Compared with the centimeter wave seeker, the millimeter wave seeker has characteristics of small size, light weight and high spatial resolution; compared with infrared, laser, TV and other optical seekers, the ability of the millimeter wave seeker penetrating, for example, fog, smoke, and dust is strong, and it has the characteristics of all-weather (except heavy rain); in addition, the anti jamming and anti-stealth capabilities of the millimeter-wave seeker are also better than other microwave seekers; the millimeter-wave radar can distinguish and identify very small targets, and can identify multiple targets at the same time, with good imaging ability, small size and good maneuverability.

In one embodiment, the method for electric power inspection includes:

S101: obtaining electric wire parameters, the electric wire parameters being acquired by a point cloud sensor during movement of the UAV, the electric wire parameters comprising a distance between the UAV and an electric wire and an extension direction of the wire.

S102: determining a flight path of the UAV based on the electric wire parameters.

S103: controlling the UAV to perform an electric power inspection operation based on the flight path of the UAV.

In one embodiment, during movement of the UAV, a point cloud sensor set on the UAV collects measurement data of the surrounding environment, and after processing (including a process of recognizing whether an obstacle is an electric wire, and further determining electric wire parameters in the case of determining that the obstacle is an electric wire, and so on), the electric wire parameters can be obtained. In practice, the data processing may be implemented on the UAV, or may be implemented on a device other than the UAV such as a cloud-side device, a ground-side device, and the like, at which time the UAV may transmit the measurement data of the surrounding environment collected by the point cloud sensor to the device other than the UAV (e.g., to the cloud via 5G), and the electric wire parameters may be returned to the UAV after being processed by the device other than the UAV. Alternatively, the device other than the unmanned aerial vehicle may identify whether the obstacle is an electric wire, and if the obstacle is identified as an electric wire, then transmit the identification of the relevant electric wire measurement data to the unmanned aerial vehicle, which determines the electric wire parameters based on the identification of the electric wire measurement data; and so on.

A frequency of the point cloud sensor to collect the data of the surrounding environment can be set according to actual needs, and the frequency of obtaining the electric wire parameters can also be determined according to actual situation. For example, if the surrounding environment is empty and there is basically no obstacle except for the electric wires, the point cloud sensor can collect the data of the surrounding environment at longer intervals, and the unmanned aerial vehicle can obtain the electric wire parameters at longer intervals; if the surrounding environment is complex, the point cloud sensor can collect the data of the surrounding environment at shorter intervals and the unmanned aerial vehicle can obtain the electric wire parameters at shorter intervals.

In one embodiment, the electric wire parameters include the distance between the unmanned aerial vehicle and the electric wire and the extension direction of the electric wire, and the distance between the unmanned aerial vehicle and the electric wire can determine the safe distance for the unmanned aerial vehicle, and the extension direction of the electric wire can determine the flight direction of the unmanned aerial vehicle, so that the flight path of the unmanned aerial vehicle can be determined according to the wire parameters. With the change of the wire parameters, the flight path of the unmanned aerial vehicle changes, which can ensure that the unmanned aerial vehicle determines the flight path in real time. The unmanned aerial vehicle determines the flight path in real time, which ensures the safety of the unmanned aerial vehicle during flight.

In one embodiment, the distance between the unmanned aerial vehicle and an electric wire includes a horizontal distance between the unmanned aerial vehicle and the electric wire and a vertical height between the unmanned aerial vehicle and the electric wire. In this way, better technical support can be provided for the unmanned aerial vehicle to avoid deflecting the electric wire as much as possible during flight and to follow the electric wire as far as possible within a safe range.

Controlling an unmanned aerial vehicle to carry out an electric power inspection operation based on a flight path of the unmanned aerial vehicle ensures, on the one hand, that the flight direction of the unmanned aerial vehicle is clear, on the other hand, that the safe flight distance between the unmanned aerial vehicle and the electric wire is ensured. The purpose of the operation of the unmanned aerial vehicle is clear: to carry out an electric power inspection operation.

One embodiment of the present application includes obtaining electric wire parameters, the electric wire parameters are collected by a point cloud sensor of the UAV during movement, the electric wire parameters include a distance between the UAV and an electric wire and an extension direction of the electric wire; determining a flight path of the UAV according to the electric wire parameters; and controlling the UAV to carry out electric power inspection operation according to the flight path of the UAV. Compared to the existing technology in which RTK data acquisition of the flight path is required for the automatic flight of the electric power inspection operation, the embodiment of the present application, because the electric wire parameters are acquired by the point cloud sensor of the UAV during its movement, determines the flight path of the UAV based on the electric wire parameters including the distance between the UAV and the electric wire as well as the extension direction of the electric wire, and controls the UAV to carry out the electric power inspection operation accordingly. In this way, the unmanned aerial vehicle can avoid various obstacles in a timely manner according to the flight path to avoid posing a threat to the unmanned aerial vehicle. Compared to the existing technology in which it is often difficult to detect thin wires in the visual detection program, the unmanned aerial vehicle of the embodiment of the present application is capable of detecting thin wires through the acquisition of the wire parameters including the distance between the unmanned aerial vehicle and the electric wires and the extension direction of the electric wires by the setup of a point-cloud sensor in the course of movement. The embodiments of the present application can be used to assist in realizing the automated operation of electric power inspection, and can ensure the safety of the unmanned aerial vehicle while enhancing the efficiency of the electric power inspection operation. If the point cloud sensor adopts millimeter-wave radar, LiDAR, or other sensors that are not affected by the ambient light, the point cloud sensor has a high anti-jamming ability.

Referring to FIG. 2, in an embodiment, the electric wire parameters are determined by the UAV, S101, the obtaining the electric wire parameters may comprise:

S1011: obtaining electric wire measurement data collected by the point cloud sensor.

S1012: determining the electric wire parameters based on the collected electric wire measurement data.

In this embodiment, the measurement data may refer to raw data collected by the point cloud sensor, and the electric wire measurement data may refer to measurement data collected by the point cloud sensor that has identified the obstacle as an electric wire. The process of identifying whether the obstacle is an electric wire may be implemented on a device other than the UAV or may be implemented on the UAV.

There are many specific ways of determining the electric wire parameters based on the collected electric wire measurement data, such as: building a three-dimensional model based on the collected electric wire measurement data, and determining the electric wire parameters in the three-dimensional model; or directly transforming the collected electric wire measurement data into some three-dimensional space, positioning the unmanned aerial vehicle in that three-dimensional space as well, and determining the electric wire parameters in that three-dimensional space; or projecting the unmanned aerial vehicle in a coordinate system in the three-dimensional space to determine the electric wire parameters, and so on.

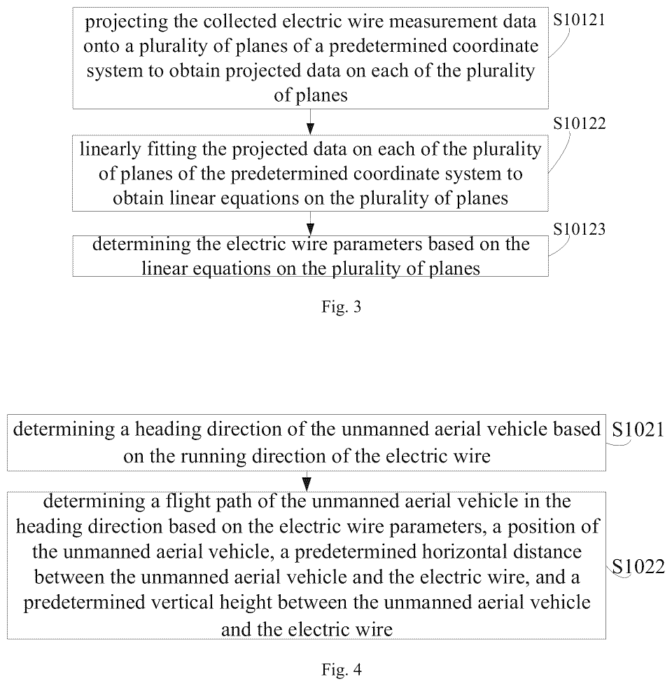

Referring to FIG. 3, in an embodiment, since the use of projection is simple, fast and does not require a lot of electric wire measurements to determine the electric wire parameters, S1012, the determining the electric wire parameters based on the collected electric wire measurement data may comprise:

S10121: projecting the collected electric wire measurement data onto a plurality of planes of a predetermined coordinate system to obtain projected data on each of the plurality of planes.

S10122: linearly fitting the projected data on each of the plurality of planes of the predetermined coordinate system to obtain linear equations on the plurality of planes.

S10123: determining the electric wire parameters based on the linear equations on the plurality of planes.

The electric wires are in dense linear form, projected on a plurality of planes of a predetermined coordinate system, and by linear fitting, the linear equations of the electric wires on the plurality of planes can be obtained, and based on the linear equations on this plurality of planes, the electric wires parameters can be determined.

In an embodiment, the predetermined coordinate system comprises a geodetic coordinate system. The geodetic coordinate system is a basic coordinate system for geodesy, with geodetic longitude L, geodetic latitude B and geodetic height H as the three coordinate components of this coordinate system; it comprises a geocentric geodetic coordinate system and a reference geodetic coordinate system. The geodetic coordinate system is a right-handed system. The right-hand system is one of the ways to specify a right-angle coordinate system in space; the positive directions of the X-axis, Y-axis and Z-axis in this coordinate system may be specified as follows: place the right hand at the origin so that the thumb, forefinger and middle finger are at right angles to each other, and point the thumb in the direction of the X-axis, and when the forefinger points to the Y-axis, the direction pointed to by the middle finger is the positive direction of the Z-axis; You can also determine the right-handed (left-handed) coordinate system as follows: If the thumb of the right hand (left hand) points in the positive direction of the first axis (X-axis), and the rest of the fingers are gripped tightly in the direction of the second axis (Y-axis) rotating around the first axis, then they coincide with the third axis (Z-axis), and the coordinate system is the right-handed (left-handed) coordinate system.

In one embodiment, the plurality of planes includes the X-Y plane and X-Z plane of the geodetic coordinate system. The horizontal distance from the UAV to the electric wire and the extension direction of the electric wire can be directly obtained by the linear equation projected onto the X-Y plane of the geodetic coordinate system; the vertical height from the UAV to the electric wire can be directly obtained by the linear equation projected onto the X-Z plane.

If the collected electric wire measurement data is not electric wire measurement data under a predetermined coordinate system, it may first be converted, i.e., S10121, the before projecting the collected electric wire measurement data onto a plurality of planes of a predetermined coordinate system, it may further comprise: converting the collected electric wire measurement data into electric wire measurement data under the predetermined coordinate system.

In an embodiment, the collected electric wire measurement data is wire measurement data in polar coordinates, and the predetermined coordinate system is a geodetic coordinate system, S10121, the converting the collected electric wire measurement data to electric wire measurement data in the predetermined coordinate system may comprise: converting the electric wire measurement data in the polar coordinates to electric wire measurement data in a body coordinate system; and converting the electric wire measurement data in the body coordinate system to the electric wire measurement data in the geodetic coordinate system.

In this embodiment, converting the electric wire measurement data in polar coordinates to electric wire measurement data in the body coordinate system can facilitate processing, and converting the electric wire measurement data in the body coordinate system to electric wire measurement data in the geodetic coordinate system can avoid the influence of the UAV's flight attitude on the measurement data collected by the point cloud sensor.

In an embodiment, if the process of recognizing whether an obstacle is an electric wire is performed by a UAV, then S1011, the obtaining the electric wire measurement data collected by a point cloud sensor may further comprise: determining, based on the measurement data collected by the point cloud sensor, whether the collected measurement data is the collected electric wire measurement data.

At this point, S1011: the obtaining electric wire measurement data collected by the point cloud sensor may further comprise: obtaining electric wire measurement data collected by the point cloud sensor when the collected measurement data is the collected electric wire measurement data.

In the collected measurement data, the electric wire is a dense linear form, and the electric wire can be recognized according to this feature, which is processed by projecting the measurement data onto a plurality of planes of a preset coordinate system, respectively, and then performing linear fitting to determine whether the measurement data is the electric wire measurement data.

That is, the determining whether the collected measurement data is the collected electric wire measurement data based on the measurement data collected by the point cloud sensor may comprise: projecting the collected measurement data onto a plurality of planes of a predetermined coordinate system; determining a degree of dispersion of the data projected onto the plurality of planes of the predetermined coordinate system; and determining, based on the degree of dispersion, whether the collected measurement data is the electric wire measurement data.

In statistics, the indicator that reflects the degree of difference between the values of individual variables in the totality of the phenomenon is called dispersion, also known as a degree of dispersion or a trend away from the center. To describe the degree of dispersion of a set of data, it is common to use extreme deviation, interquartile deviation, variance and standard deviation, and coefficient of variation.

In one embodiment, the determining whether the collected measurement data is the electric wire measurement data based on the degree of dispersion may comprise: determining that the collected measurement data is the collected electric wire measurement data if the degree of dispersion is less than or equal to a predetermined threshold; and determining that the collected measurement data is an obstacle measurement data other than the electric wire measure data if the degree of dispersion is greater than a predetermined threshold.

The smaller the degree of dispersion, the smaller the degree of difference between the measurement data, and the higher the likelihood that the obstacle corresponding to the measurement data is an electric wire. A predetermined threshold is determined in advance by way of experimentation based on a specific practical application, a specific way of describing the degree of dispersion, etc.. If the degree of dispersion is less than or equal to the predetermined threshold, it is determined that the collected measurement data is the collected electrical wire measurement data, and if the degree of dispersion is greater than the predetermined threshold, it is determined that the collected measurement data is measurement data of an obstacle other than the electrical wire.

In one embodiment, the determining a degree of dispersion of the projected data on the plurality of planes of the predetermined coordinate system may further comprise: S101321: linearly fitting the data projected onto the plurality of planes of the predetermined coordinate system separately to obtain linear equations on the plurality of planes; and determining the degree of dispersion based on the linear equations on the plurality of planes.

In this embodiment, after obtaining the equations of the lines on the plurality of planes, the dispersion can be determined by the way the variance and standard deviation, the coefficient of variation, and so on, are described.

In one embodiment, if the collected measurement data is not measurement data under the predetermined coordinate system, the projecting the collected measurement data onto the plurality of planes of the predetermined coordinate system may further comprise: converting the collected measurement data into measurement data under the predetermined coordinate system.

In an embodiment, the collected measurement data is electric wire measurement data in polar coordinates, the predetermined coordinate system is a geodetic coordinate system, the converting the collected measurement data into measurement data in the predetermined coordinate system may further comprise: converting the measurement data in polar coordinates into measurement data in a body coordinate system; and converting the measurement data in the body coordinate system into measurement data in the geodetic coordinate system.

In one embodiment, converting the measurement data under the polar coordinates to the measurement data under the body coordinate system can facilitate processing, and converting the measurement data under the body coordinate system to the measurement data under the geodetic coordinate system can avoid the influence of the UAV flight attitude on the measurement data collected by the point cloud sensor.

In one embodiment, it is to be noted that if the process of recognizing whether an obstacle is an electric wire is performed by the UAV, and the process of determining the electric wire parameters is performed by the UAV, the steps repeated in the two processes may be omitted in the process of determining the electric wire parameters by the UAV, such as the process of converting the measured data in different coordinate systems, the process of projection, and so on.

In one embodiment, determining the flight path of the UAV needs to be combined with the user's preset requirements in addition to considering the electric wire parameters to further satisfy the user's needs. That is, S102, the determining a flight path of the UAV based on the electric wire parameters may further comprise: determining a flight path of the UAV based on the electric wire parameters and a preset requirement for the UAV to follow the electric wire.

Wherein, referring to FIG. 4, S102, the determining a flight path for the UAV based on the electric wire parameters and a predetermined requirement for the UAV to follow the electric wire may further comprise:

S1021: determining a heading direction of the unmanned aerial vehicle based on the extension direction of the electric wire.

S1022: determining a flight path of the unmanned aerial vehicle in the heading direction based on the electric wire parameters, a position of the unmanned aerial vehicle, a predetermined horizontal distance between the unmanned aerial vehicle and the electric wire, and a predetermined vertical height between the unmanned aerial vehicle and the electric wire.

In this embodiment, the unmanned aerial vehicle follows the electric wire, and the heading direction of the unmanned aerial vehicle is determined based on the extension direction of the electric wire, and the direction of flight may be approximately consistent with the extension direction of the electric wire. The user has pre-set a pre-determined horizontal distance between the unmanned aerial vehicle and the electric wire, and a pre-determined vertical height between the unmanned aerial vehicle and the electric wire, and based on the electric wire parameters, and the position of the unmanned aerial vehicle, the flight path of the unmanned aerial vehicle in the heading direction can be determined.

In an embodiment, if the obstacle is an obstacle other than an electric wire, the UAV needs to make specific measures based on the actual location of that obstacle other than an electric wire. That is, the method may further comprise:

(A) If an obstacle other than an electric wire is detected, determining whether the obstacle is within the flight path of the UAV, the obstacle being determined by measurements collected by the point cloud sensor during the movement of the UAV.

(B) If the obstacle is within the flight path of the UAV, control the UAV to enter an obstacle avoidance mode to avoid the obstacle.

(C) Ignoring the obstacle if the obstacle is outside the flight path of the UAV.

The following is an example of rotating millimeter wave radar, using a projection to illustrate the complete process of identifying whether an obstacle is an electric wire, and determining the electric wire parameters, as performed by a UAV.

The rotating millimeter wave radar according to one embodiment of the present application is mounted on the top of the UAV, scans the information of obstacles including an electric wire, recognizes and acquires the horizontal distance between the electric wire and the UAV, the vertical height, and the extension direction of the wire, and the UAV controls the UAV to automatically follow the electric wire through these electric wire parameters. The main realization steps of this embodiment can be divided into: acquisition of measurement data of the rotating millimeter wave radar, coordinate conversion, identification of the electric wire, determination of the electric wire parameters, and identification of the obstacles, as follows:

(1) Acquisition Measurement data of a rotating millimeter wave radar:

A rotating millimeter wave radar uses an electrical scanning mode in a vertical direction and uses a mechanical scanning mode in a horizontal direction. Through the combination of the two scanning modes can be a full range of electromagnetic wave coverage of the space target. The radar antenna receives the target's reflected wave, which is used through a signal processing module to get the target's distance r, horizontal angle α, pitch angle β. The radar processes all the reflections of the spatial targets to obtain the point cloud data (i.e., measurement data) in the surrounding environmental information, namely(r₀, a₀, β₀), (r₁, a₁, β₁), . . . , (rₙ, aₙ, βₙ)

(2) Coordinate conversion:

The radar scanning environment is the point cloud data in the polar coordinates. In order to facilitate processing. the original point cloud data needs to be converted to the body coordinate system (front-right-bottom). Assuming that the body coordinates are (x_{b} y_{b} z_{b}), the coordinate conversion is as follows:

$$\{ \begin{matrix}{x}_{b} = r sin β cos α \\ {y}_{b} = r sin β cos α \\ {z}_{b} = r cos β\end{matrix}$$

The UAV flight attitude has an effect on the measurement data collected by the radar, and its point cloud data can be transformed from the body coordinate system to the geodetic coordinate system (north-east-earth), assuming that the aircraft's heading angle is Ø and the roll angle is θ and the pitch angle is φ and the geodetic coordinates are (x Y z), the coordinate conversion is as follows:

$$[ \begin{matrix}x \\ y \\ z\end{matrix} ] = [ \begin{matrix}cos θ cos ∅ & sin φ sin θ cos ∅ - cos φ sin ∅ & cos φ sin θ cos ∅ + sin φ sin ∅ \\ cos θ sin ∅ & sin φ sin θ sin ∅ + cos φ cos ∅ & cos φ sin θ cos ∅ - sin φ cos ∅ \\ - sin θ & sin φ cos θ & cos φ cos θ\end{matrix} ] [ \begin{matrix}{x}_{b} \\ {y}_{b} \\ {z}_{b}\end{matrix} ]$$

(3) Wire identification:

In the radar point cloud data, the electric wires are dense linear form, the wires can be recognized according to this feature. The processing is to project the point cloud data of the wires to the three planes X-Y, X-Z, and Y-Z, respectively, and then use the least squares method of linear fitting of y=kx+b for the data on each plane to get the dispersion of the data on each plane, assuming that the dispersion of the data on the three planes are εₐ, ε_{b}, and ε_{c}. If the dispersion of the data is within a pre-set pre-determined threshold T, i.e.

$$\{ \begin{matrix}{ε}_{a} \leq T \\ {ε}_{b} \leq T \\ {ε}_{c} \leq T\end{matrix}$$

Then, the point cloud data is determined to be the point cloud data of the electric wire (i.e., wire measurement data). Otherwise, it is the point cloud data of the obstacle (i.e., obstacle measurement data).

(4) Determination of electric wire parameters:

The point cloud data with the target identified as the electric wire is linearly fitted in the X-Y plane, and the linear equation y=kx+b can be obtained using the least squares method or the Random Sample Consensus Algorithm (RANSAC), which gives the horizontal distance from the UAV to the electric wire:

$$L = \frac{\vert b \vert}{\sqrt{1 + {k}^{2}}}$$

Where the extension direct of the electric wire:

θ_{L}=a tan(k)

The point cloud data is then projected onto the X-Z plane and linearly fitted to obtain the linear equation z=kx+d, with d being the vertical height between the UAV and the electric wire.

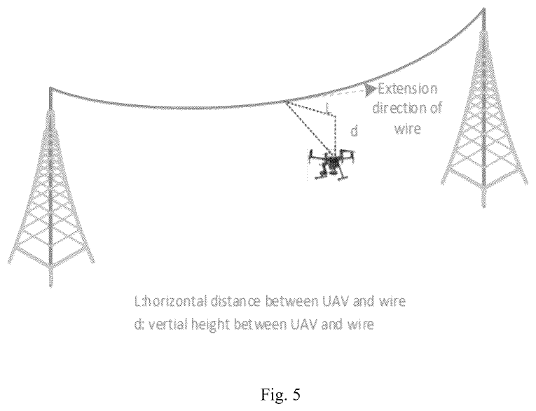

As shown in FIG. 5, after obtaining the electric wire parameters including the horizontal distance L and vertical height d of the UAV relative to the electric wire, as well as the extension direction of the electric wire, θ_{L}, the UAV can accomplish the task of automatically tracking the electric wire.

(5) Identification of obstacles:

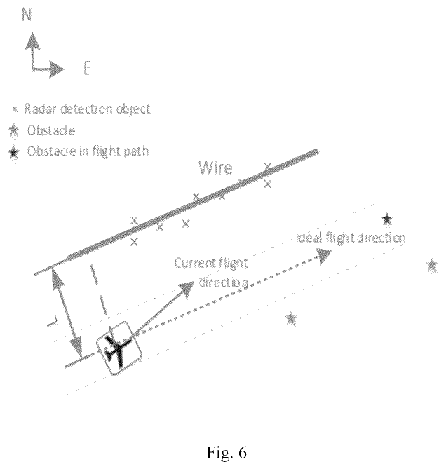

For the point cloud data where the target is an obstacle that is not an electric wire, the target can be judged to be an obstacle. The obstacle can be ignored if it is not within the UAV's flight path, as shown in FIG. 6. The UAV can set a safety distance M (which can be the preset horizontal distance between the UAV and the electric wire and the preset vertical height between the UAV and the electric wire) during operation, so that the threat of obstacles can be judged according to the direction of flight and the safety distances. If the obstacle is in the flight path of the UAV, the UAV will decelerate the brake to enter the obstacle avoidance mode to pause the operation, and obstacles are ignored if they are not within the UAV's flight path.

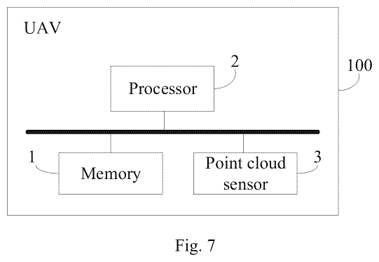

Referring to FIG. 7, FIG. 7 is a schematic diagram of a structure of a UAV of an embodiment of the present application, it is to be noted that the UAV of the present embodiment is capable of performing the operations in the method of electric power inspection, and for a detailed description of the relevant contents, please refer to the relevant contents of the method of electric power inspection mentioned above, which will not be repeated herein.

In one embodiment, the UAV 100 is provided with a point cloud sensor 3, the UAV 100 further comprising: a memory 1 and a processor 2; the processor 2 is connected to the memory 1 and the point cloud sensor 3 via a bus.

The processor 2 may be a micro-control unit, a central processing unit or circuitry or a digital signal processor, among others.

The memory 1 may be a Flash chip, read-only memory, disk, CD-ROM, USB flash drive, or removable hard drive, among others.

The memory 1 is used to store instructions; the processor 2 calls the instructions stored in the memory for realizing the following operations:

Obtaining electric wire parameters, the electric wire parameters being acquired by the point cloud sensor during movement of the UAV, the electric wire parameters including a distance between the UAV and an electric wire and an extension direction of the electric wire; determining a flight path of the UAV based on the electric wire parameters; controlling the UAV to carry out an electric power inspection operation based on the flight path of the UAV.

In one embodiment, the distance between the unmanned aerial vehicle and the electric wire includes a horizontal distance between the unmanned aerial vehicle and the electric wire and a vertical height between the unmanned aerial vehicle and the electric wire.

In one embodiment, the processor is specifically used to: obtain electric wire measurement data collected by the point cloud sensor; determine the electric wire parameters based on the collected wire measurement data.

In one embodiment, the processor is specifically used to: project the collected wire measurement data onto a plurality of planes of a predetermined coordinate system; perform a linear fit on the data projected onto the plurality of planes of the predetermined coordinate system respectively to obtain linear equations on the plurality of planes; and determine the wire parameters based on the linear equations on the plurality of planes.

In one embodiment, the predetermined coordinate system comprises a geodetic coordinate system.

In one embodiment, the plurality of planes includes an X-Y plane and an X-Z plane of the geodetic coordinate system.

In one embodiment, the processor is specifically used to: convert the collected wire measurement data into wire measurement data in the predetermined coordinate system.

In one embodiment, the collected wire measurement data is wire measurement data in polar coordinates, the predetermined coordinate system is a geodetic coordinate system, the processor is specifically used for: converting the wire measurement data in polar coordinates to wire measurement data in the body coordinate system; converting the wire measurement data in the body coordinate system to wire measurement data in the geodetic coordinate system.

In one embodiment, the processor is specifically used to: determine whether the collected measurement data is wire measurement data based on the measurement data collected by the point cloud sensor; obtain the wire measurement data collected by the point cloud sensor in the event that the collected measurement data is the collected wire measurement data.

In one embodiment, the processor is specifically used to: project the collected measurement data onto a plurality of planes of a predetermined coordinate system; determine a degree of dispersion of the data projected onto the plurality of planes of the predetermined coordinate system; and determine, based on the degree of dispersion, whether or not the collected measurement data is the collected wire measurement data.

In one embodiment, the processor is specifically used to: if the degree of dispersion is less than or equal to a predetermined threshold, determine that the captured measurement data is the captured wire measurement data; if the degree of dispersion is greater than a predetermined threshold, determine that the captured measurement data is an obstacle measurement data other than the wire.

In one embodiment, the processor is specifically used to: linearly fit the data projected onto the plurality of planes of the predetermined coordinate system separately to obtain linear equations on the plurality of planes; and determine the degree of dispersion based on the linear equations on the plurality of planes.

In one embodiment, the processor is specifically used to: convert the collected measurement data into measurement data in the predetermined coordinate system.

In one embodiment, the collected measurement data is wire measurement data in polar coordinates, the predetermined coordinate system is a geodetic coordinate system, and the processor is specifically used to: convert the measurement data in polar coordinates to measurement data in a body coordinate system; and convert the measurement data in the body coordinate system to measurement data in a geodetic coordinate system.

In one embodiment, the processor is specifically used to: determine a flight path for the UAV based on the wire parameters and a predetermined requirement for the UAV to follow the wire.

In one embodiment, the processor is specifically used to: determine a heading direction of the unmanned aerial vehicle based on an extension direction of the electric wire; determine a flight path of the unmanned aerial vehicle in the heading direction based on the electric wire parameters, a position of the unmanned aerial vehicle, a predetermined horizontal distance between the unmanned aerial vehicle and the electric wire, and a predetermined vertical height between the unmanned aerial vehicle and the electric wire.

In one embodiment, the processor is specifically used to: if an obstacle other than an electric wire is detected, determine whether the obstacle is within the flight path of the UAV, the obstacle being determined by measurements collected by the point cloud sensor during movement of the UAV; if the obstacle is within the flight path of the UAV, control the UAV to enter an obstacle avoidance mode to avoid the obstacle; if the obstacle is outside the flight path of the UAV, ignoring the obstacle.

In one embodiment, the point cloud sensor comprises a rotating millimeter wave radar.

In one embodiment, the present application also provides a non-transitory computer readable storage medium, the computer readable storage medium storing a computer program, the computer program when executed by a processor causing the processor to implement an electrical power patrol method as described in any one of the preceding claims.

Wherein the computer-readable storage medium may be an internal storage unit of the aforementioned unmanned aerial vehicle, such as a hard disk or memory. The computer-readable storage medium may also be an external storage device, such as an equipped plug-in hard disk, a smart memory card, a secure digital card, a flash memory card, and the like.

It should be understood that the terminology used in this application specification is used solely for the purpose of describing particular embodiments and is not intended to limit the application.

It should also be understood that the term “and/or” as used in this application specification and the appended claims refers to and includes any combination and all possible combinations of one or more of the items listed in association.

The foregoing are only specific embodiments of the present application, but the scope of protection of the present application is not limited thereto, and any person skilled in the art can easily think of various equivalent modifications or substitutions within the scope of the technology disclosed in the present application, which shall be covered by the scope of protection of the present application. Therefore, the scope of protection of this application shall be subject to the scope of protection of the claims.

What is claimed is:

1. An operating method of an aerial vehicle, comprising:
obtaining target parameters, the target parameters being acquired by an on-board sensor of the aerial vehicle during movement of the aerial vehicle, the target parameters comprising a distance between the aerial vehicle and a target object and an extension direction of the target object;
determining a flight path of the aerial vehicle based on the target parameters; and
controlling the aerial vehicle to perform an operation based on the flight path of the aerial vehicle.

2. The operating method according to claim 1, wherein the target object comprises an electric wire.

3. The operating method according to claim 1, wherein the on-board sensor comprises a point cloud sensor.

4. The operating method according to claim 3, wherein the point cloud sensor comprises at least one of the following: a lidar, a visible camera, a multispectral camera, a millimeter wave radar, a rotating millimeter wave radar, or an ultrasonic radar.

5. The operating method according to claim 1, wherein a heading direction of the aerial vehicle is substantially aligned with the extension direction of the target object.

6. The operating method according to claim 2, wherein the distance between the aerial vehicle and the electric wire includes a horizontal distance between the aerial vehicle and the electric wire and a vertical height between the aerial vehicle and the electric wire.

7. The method according to claim 1, wherein the obtaining target parameters comprises:
obtaining target measurement data collected by the on-board sensor; and
determining the target parameters based on the collected target measurement data.

8. The operating method according to claim 7, prior to the obtaining target measurement data collected by the on-board sensor, further comprising:
determining whether measurement data collected by the on-board sensor is the target measurement data;
the obtaining target measurement data collected by the on-board sensor comprises:
obtaining the target measurement data collected by the on-board sensor when the measurement data is determined to be the target measurement data.

9. The operating method according to claim 8, wherein the determining whether the measurement data collected by the on-board sensor is the target measurement data comprises:
determining whether the measurement data is the target measurement data based on a dispersion of the measurement data.

10. The operating method according to claim 9, wherein the determining whether the measurement data is the target measurement data based on the dispersion of the measurement data comprises:
under a condition that the dispersion is less than or equal to a predetermined threshold, the measurement data is determined to be the target measurement data; and
under a condition that the dispersion is greater than the predetermined threshold, the measurement data is determined to be obstacle measurement data, which is measurement data of an obstacle other than the target object.

11. The operating method according to claim 1, wherein the determining the flight path of the aerial vehicle based on the target parameters comprises:
determining the flight path of the aerial vehicle based on the target parameters and a predetermined requirement for the aerial vehicle to follow the target object.

12. The operating method according to claim 11, wherein the determining the flight path of the aerial vehicle based on the target parameters and the predetermined requirement for the aerial vehicle to follow the target object comprises:
determining a heading direction of the aerial vehicle based on the extension direction of the target object; and
determining the flight path of the aerial vehicle in the heading direction based on the target parameters, a position of the aerial vehicle, and a predetermined distance between the aerial vehicle and the target object.

13. The operating method according to claim 1, further comprising:
determining presence of an obstacle other than the target object, the obstacle being determined by measurement data collected by the on-board sensor during the movement of the aerial vehicle;
under a condition that the obstacle is determined to be within the flight path of the aerial vehicle, controlling the aerial vehicle to enter an obstacle avoidance mode to avoid the obstacle; and
under a condition that the obstacle is determined to be outside the flight path of the aerial vehicle, controlling the aerial vehicle to ignore the obstacle.

14. An aerial vehicle having an on-board sensor, further comprising: a memory and a processor;
the memory is used to store instructions;
the processor calls the instructions stored in the memory for realizing following operations:
obtaining target parameters, the target parameters being acquired by an on-board sensor of the aerial vehicle during movement of the aerial vehicle, the target parameters comprising a distance between the aerial vehicle and a target object and an extension direction of the target object;
determining a flight path of the aerial vehicle based on the target parameters; and
controlling the aerial vehicle to perform an operation based on the flight path of the aerial vehicle.

15. The aerial vehicle according to claim 14, wherein the target object comprises an electric wire.

16. The aerial vehicle according to claim 14, wherein the on-board sensor comprises a point cloud sensor.

17. The aerial vehicle according to claim 16, wherein the point cloud sensor comprises at least one of the following: a lidar, a visible camera, a multispectral camera, a millimeter wave radar, a rotating millimeter wave radar, or an ultrasonic radar.

18. The aerial vehicle according to claim 14, wherein a heading direction of the aerial vehicle is substantially aligned with the extension direction of the target object.

19. The aerial vehicle according to claim 14, wherein the distance between the aerial vehicle and the target object includes a horizontal distance between the aerial vehicle and the target object and a vertical height between the aerial vehicle and the target object.

20. The aerial vehicle according to claim 14, wherein the determining the flight path of the aerial vehicle based on the target parameters comprises:
determining the flight path of the aerial vehicle based on the target parameters and a predetermined requirement for the aerial vehicle to follow the target object.
